(19) United States
(12) Patent Application Publication
(10) Pub. No.: US 2006/0232475 A1
(43) Pub. Date: Oct. 19, 2006

(54) Dual-band strip antenna supporting left-hand and right-hand circular polarization

(75) Inventors: Yuh-Hui Huang, Taoyuan City (TW); Ching-Shu Fang, Taoyuan City (TW)

Correspondence Address: HDSL, 4331 STEVENS BATTLE LANE, FAIRFAX, VA, 22033, US

(73) Assignee: Cirex Technology Corporation

(21) Appl. No.: 11/106,494

(22) Filed: Apr. 15, 2005

(51) Int. Cl. H01Q 1/38

(52) U.S. Cl. 343/700 MS

(57) ABSTRACT

A dual-band strip antenna supporting left-hand circular polarization and right-hand circular polarization includes at least a first base and a second base stacked to each other, an antenna conductor coated between the two bases, and a feeder connected to the antenna conductor through indirect capacitor coupling. The antenna conductor includes a bottom metal layer coated on the bottom of the first base through pattern defining and functioned as a bottom ground conductor; a second metal layer coated on a surface of the first base through pattern defining, the second metal layer functioned as low-frequency band antenna and a bottom ground electrode of the second base; a top metal layer coated on a surface of the second base through pattern defining, the top metal layer functioned as high-frequency band antenna. The dual-band strip antenna of the present invention overcomes the problem of necessity of switch, low efficient and high cost.

### BACKGROUND OF THE INVENTION

1. Field of the Invention

The present invention relates to dual-band strip antenna supporting left-hand circular polarization and right-hand circular polarization, especially to a dual-band strip antenna integrating the circuit of left-hand circular polarization and the circuit of right-hand circular polarization together, thus supporting left-hand and right-hand circular polarization simultaneously for platforms of dual frequency band.

2. Description of Prior Art

Antennas providing circular-polarization are extensively used for satellite receiver terminal. The GPS, SDAR and satellite TV generally employs strip antennas for receiving signal. To provide the application for dual-band frequencies and dual polarization, two antennas operated at different frequencies and different polarizations modes are used with a switch to switch the feeding points of the two antennas. However, the conventional antenna cannot be simultaneously operated at dual frequencies. Therefore, the conventional antenna cannot be integrated to two different platforms. Moreover, a plurality of feeding points and switch are required. The assembling thereof is complicated, the cost is high and the yield is degraded.

### SUMMARY OF THE INVENTION

The present invention provides a dual-band strip antenna integrating the circuit of left-hand circular polarization and the circuit of right-hand circular polarization together, thus supporting left-hand and right-hand circular polarization simultaneously for platforms of dual frequency band.

Accordingly, the present invention provides a dual-band strip antenna supporting left-hand circular polarization and right-hand circular polarization, which includes at least a first base and a second base stacked to each other, an antenna conductor coated between the two bases, and a feeder connected to the antenna conductor through indirect capacitor coupling. The antenna conductor comprises a bottom metal layer coated on the bottom of the first base through pattern defining and functioned as a bottom ground conductor; a second metal layer coated on a surface of the first base through pattern defining, the second metal layer functioned as low-frequency band antenna and a bottom ground electrode of the second base; a top metal layer coated on a surface of the second base through pattern defining, the top metal layer functioned as high-frequency band antenna. The dual-band strip antenna of the present invention overcomes the problem of necessity of switch, low efficient and high cost.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a perspective view of the dual-band strip antenna of the present invention.

FIG. 2 shows the radiation pattern of the dual-band strip antenna of the present invention.

FIG. 3 shows a relationship between return loss (dB) and frequency (GHz) for the dual-band strip antenna of the present invention.

### DETAILED DESCRIPTION OF THE INVENTION

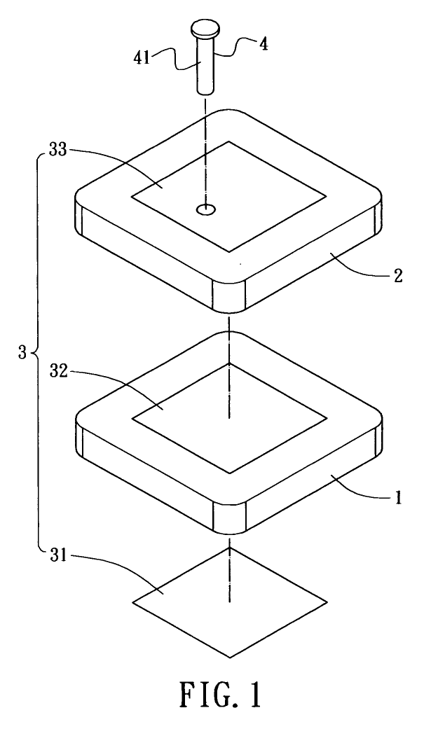

FIG. 1 shows a schematic diagram of the dual-band strip antenna with right/left circular polarization operation. The dual-band strip antenna comprises two bases 1 and 2 stacked to each other, an antenna conductor 3 formed on the surface of the base 1 and the base 2 and defined through pattern. A metal layer 33 is formed on the surface o the second base 2 to provide a transmission circuit for a feeder 4, thus forming a high efficiency and simultaneously workable dual-band strip antenna. The dual-band strip antenna can be applied to mobile satellite terminal with demanding research pressure, such as mobile phone, GPS, SDAR, satellite TV broadcast receiver.

The bases 1 and 2 are made of material with low-loss and high dielectric constant. The material can be ceramic such as aluminum oxide and titanium zirconate and engineering plastic such as PS`PTFE`PEEK`FR4 as long as the dielectric constant is larger than or equal to 1. The bases 1 and 2 are made into panel shape and are stacked to form an integral composite structure.

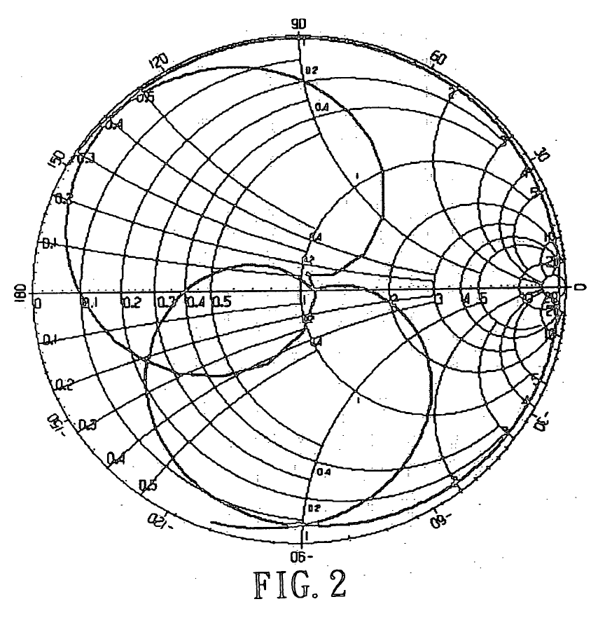

Accordingly a preferred embodiment of the present invention, the antenna conductor 3 comprises a bottom metal layer 31, a second metal layer 32 and a top metal layer 33 with high Q value and anti-oxidation property. The bottom metal layer 31 is coated on the bottom of the first base 1 through pattern defining and functioned as bottom ground conductor. The second metal layer 32 is a right-hand circular polarization metal plate and coated on the surface of the first base 1 through pattern defining. The second metal layer 32 is functioned as low-frequency band antenna and bottom ground electrode of the second base 2. The second metal layer 32 is not connected to the feeder 4. The top metal layer 33 is a left-hand circular polarization metal plate and coated on the surface of the second base 2 through pattern defining. The top metal layer 33 is functioned as high-frequency band antenna and is connected to the feeder 4, thus forming an integral dual-band antenna with left-hand circular polarization and right-hand circular polarization ability. The antenna has radiation field pattern with dual band characteristics. As shown in FIG. 2, the integral dual-band antenna has left-hand circular polarization and right-hand circular polarization characteristics.

Accordingly a preferred embodiment of the present invention, the feeder 4 is a feeding terminal 41 directly feeding to the top metal layer 33. Moreover, the feeder 4 can also be formed by indirectly capacitor coupling and feeds to the top metal layer 33.

The antenna conductor 3 comprises the bottom metal layer 31, the second metal layer 32 and the top metal layer 33 with high Q value and anti-oxidation property, and is placed between the two bases 1 and 2 to form an integral composite dual-band antenna supporting left-hand circular polarization and right-hand circular polarization. The dual-band strip antenna of the present invention overcomes the problem of necessity of switch, low efficient and high cost.

Therefore, the present invention provides the integral composite dual-band antenna supporting left-hand circular polarization and right-hand circular polarization. The dual-band can be operated simultaneously for two kinds of platforms.

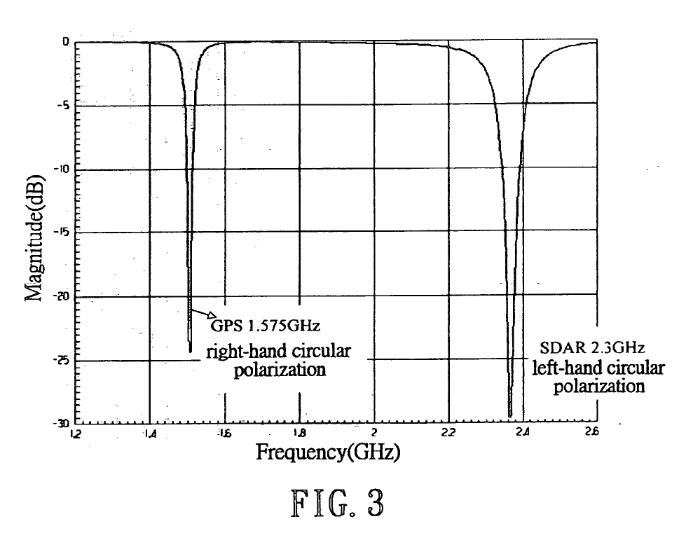

FIG. 3 shows a relationship between return loss (dB) and frequency (GHz) for the integral composite dual-band antenna supporting left-hand circular polarization and right-hand circular polarization according to the present invention. When the dual-band strip antenna is operated in GPS system, the center frequency is 1575.42 MHz and the bandwidth is 2 MHz. When the dual-band strip antenna is operated in XM system of SDAR in North America, the center frequency is 2338 MHz and the bandwidth is 2 t MHz. When the dual-band strip antenna is operated in SIRIUS system, the center frequency is 2326 MHz and the bandwidth is 25 MHz.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1-11. (canceled)

12. A dual-band strip antenna used for satellite terminal, comprising:
a first panel base and a second panel base stacked thereon; and
an antenna conductor coated between surfaces of the first panel base and the second panel base, including:
a bottom metal layer individually coated at center of a bottom surface of the first panel base and functioned as a bottom ground conductor of the first panel base;
an intermediate metal layer as a right-hand circular polarization metal plate, individually coated at center of a top surface of the first panel base and functioned as low-frequency band antenna and a bottom ground electrode of the second panel base;
a top metal layer as a left-hand circular polarization metal plate, individually coated on at center of a top surface of the second panel base and functioned as high-frequency band antenna; and
a feeder feeding to the antenna conductor by connecting merely to the top metal layer.

13. The dual-band strip antenna as in claim 12, wherein the feeder is a feeding terminal or an indirectly coupling capacitor.

14. The dual-band strip antenna as in claim 1, wherein the two bases are made of low loss and high dielectric constant material.

15. The dual-band strip antenna as in claim 14, wherein the two bases are made of ceramic dielectric material or material with dielectric constant larger than or equal to one.

16. The dual-band strip antenna as in claim 12, wherein the metal layers have high Q value and anti-oxidation property.
